(19) United States
(12) Patent Application Publication
(10) Pub. No.: US 2018/0016952 A1
(43) Pub. Date: Jan. 18, 2018

(54) SEALING UNIT AND FLUID ENGINE

(71) Applicant: Fluid Energy Solutions International Limited, Birmingham, West Midlands (GB)

(72) Inventors: Graham Stuart Lucking, West Midlands (GB); Timothy Stephen Hordley, West Midlands (GB); Harry Martin Buffery, West Midlands (GB); Don Charles Palmer, West Midlands (GB)

(21) Appl. No.: 15/548,436

(22) PCT Filed: Feb. 3, 2016
(86) PCT No.: PCT/GB2016/050250

§ 371 Date: Aug. 3, 2017

(30) Foreign Application Priority Data
Feb. 3, 2015 (GB) 1501788.2
Dec. 23, 2015 (GB) 1522735.8

(51) Int. Cl. F01L 3/08; F16K 41/04; F02B 75/02; F01P 3/02; F01L 1/04

(52) U.S. Cl. CPC F01L 3/08; F16K 41/04; F02B 75/02; F02B 2075/025; F01L 1/04; F01P 2003/024; F01P 3/02; F02B 2075/027

(57) ABSTRACT

A valve stem sealing unit (65) for forming a seal round a valve stem (41, 43) of a poppet valve (19, 21) in an engine (1) having a body (5, 7, 13) and operated by a working fluid, the valve stem sealing unit (65) including: a housing (67) defining a through passage (79) running from a first end to a second end, the through passage (69) being arranged to receive a portion of the valve stem (41, 43); a first seal (85) arranged to form a seal between the valve stem (41, 43) and the housing (69) to prevent egress of the working fluid from the first end of the housing (69); and a second seal (89) arranged to form a seal between the housing (69) and a body (5, 7, 13) of the engine (1) to prevent egress of the working fluid from the second end of the housing (69).

The present invention relates to a sealing unit for a fluid engine, and a method of manufacturing a fluid engine.

In a wide variety of situations, fluids can undergo a pressure change, sometimes with an associated state change. The change (state or pressure) can be accompanied by a release of energy, if there is a reduction in the pressure. This energy is often allowed to dissipate to the surrounding environment. In many situations, this energy could be harnessed.

A fluid engine is an engine that is driven by such a pressure or state change. The fluid used to drive the engine is known as the working fluid. In the context of this application, a fluid can be used to mean any substance in its liquid, vapour or gas phase, including but not limited to a substance in a mixture of liquid and/or vapour and/or gas phase. The vapour phase is differentiated from the gas phase in that the gas is close to the saturation point, where it condenses into a liquid, whereas in the gas phase, the gas is not close to the saturation point.

Some existing fluid engines are based on turbine technology. This makes them complex and expensive to make, since a high degree of precision and strength is required. Furthermore, existing fluid engines are highly application specific, meaning that a whole new engine must be designed for each application and working fluid. Other fluid engines may be based on internal combustion engines, but these work at low pressure, with compressed air as the working fluid.

Working fluids in fluid engines are often under higher pressures than in internal combustion engines. This means that typical valve seals used in internal combustions engines do not provide sufficient sealing, resulting in leakage of working fluids. This may be particularly problematic where leaking of the working fluid may have environmental impact.

According to a first aspect of the invention, there is provided a valve stem sealing unit for forming a seal round a valve stem of a poppet valve in an engine having a body and operated by a working fluid, the valve stem sealing unit including: a housing defining a through passage running from a first end to a second end, the through passage being arranged to receive a portion of the valve stem; a first seal arranged to form a seal between the valve stem and the housing to prevent egress of the working fluid from the first end of the housing; and a second seal arranged to form a seal between the housing and a body of the engine to prevent egress of the working fluid from the second end of the housing.

The valve stem sealing unit provides a tight seal around a valve stem, allowing an engine including the sealing unit to operate at higher pressures than one with typical valve seals. This is particularly advantageous where the engine is a fluid engine driven by the expansion of a working fluid that is harmful to the environment, where leakage should be prevented as far as possible.

The second seal may be arranged to form a seal between the housing and a valve guide of the engine.

The housing may be arranged such that a top of the valve guide forms a seat for the first seal.

The housing may be arranged such that a step change in the outer surface of the valve guide forms a seat for the second seal.

The housing may comprise a cylindrical wall, arranged around the valve stem, and a top wall, at a top end adjacent the first seal.

The through passage may be constructed and arranged to accommodate a valve guide of the engine.

The housing may include an annular flange extending from a bottom end of the cylindrical wall, adjacent the second seal.

The housing may form a spring guide or spring seat for a spring arranged to bias the valve to a closed position.

In use, the spring may compress the first seal and second seal such that a tight seal is formed.

The through passage may include formations arranged to engage and compress the seals.

The first seal may comprise a pair of annular seals, separated by a washer, a first of the pair of annular seals being arranged to form a seal between the valve stem and the housing to prevent egress of the working fluid from the first end of the housing, and a second of the pair of annular seals being arranged to form a seal between the valve stem and the housing to prevent egress of the working fluid from between the valve stem and the body of the engine.

The second of the pair of annular seals may have a diameter smaller than the first of the pair of annular seals.

The second of the pair of annular seals may have a diameter smaller than the valve stem, such that the second of the pair of annular seals is stretched, in use.

According to a second aspect of the invention, there is provided a fluid engine having a piston, received in a cylinder, the piston being driven, in use, by a pressure change in a working fluid, the engine including: an inlet valve for controlling ingress of the working fluid into the cylinder, the inlet valve having an inlet valve stem passing through a first aperture in a body of the engine; an outlet valve for controlling the exhaust of the working fluid from the cylinder, the outlet valve having an outlet valve stem passing through a second aperture in a body of the engine; a first valve stem sealing unit according to the first aspect arranged to seal the inlet valve stem; and a second valve stem sealing unit according to the first aspect arranged to seal the outlet valve stem.

The fluid engine is able to operate at high pressures due to the valve sealing units, without risk of leakage of a working fluid driving the engine. This is particularly advantageous where the engine is a fluid engine driven by the expansion of a working fluid that is harmful to the environment.

According to a third aspect of the invention, there is provided a fluid engine arranged to be driven by a change in pressure of a working fluid, the fluid engine having one or more possible leakage points, and including a working fluid collecting system to collect any working fluid that leaks from the leakage points, the working fluid collecting system including: a cover constructed and arranged to form a sealed space around at least one of the leakage points; means for condensing working fluid leaking into the cover; and means for collecting the condensed working fluid.

The fluid engine is able to collect any working fluid that leaks out of the engine, preventing it from escaping into the atmosphere. This is particularly advantageous where the engine is a fluid engine driven by the expansion of a working fluid that is harmful to the environment.

The means for condensing the working fluid may include a heat exchange fluid at lower temperature than the working fluid, such that heat exchange between the working fluid and heat exchange fluid cools the working fluid.

The means for condensing the working fluid may include a heat exchanger for exchanging heat between the working fluid and the heat exchange fluid.

The means for condensing the working fluid may include a first feed for supplying working fluid from the space formed by the cover to the heat exchanger, and a second feed for supplying working fluid from the heat exchanger to the means for collecting the condensed working fluid.

The means for condensing the working fluid may include a cooling jacket arranged around the cover, such that the working fluid condenses in the space formed by the cover.

The means for condensing the working fluid may include a first feed for supplying condensed working fluid from the spaced formed by the cover to the means for collecting the condensed working fluid.

The space formed by the cover may be held in an inert nitrogen environment.

The means for collecting the condensed working fluid may include a separator for separating the working fluid from the nitrogen.

The working fluid collecting system may include means for recycling nitrogen from the separator to the space formed by the cover.

The working fluid collecting system may include means for recycling collected working fluid to the input or output of the fluid engine.

The working fluid collecting system may include means for drawing working fluid through the working fluid collecting system.

The fluid engine may include a piston, received in a cylinder, the piston being driven, in use, by the pressure change in the working fluid.

The fluid engine may include an inlet manifold for supplying working fluid to the cylinder; and an outlet manifold for exhausting working fluid from the cylinder, wherein the joins where the inlet manifold and outlet manifold connect to a body of the engine form leakage points.

The fluid engine may include an inlet valve for controlling ingress of the working fluid into the cylinder, the inlet valve having an inlet valve stem passing through a first aperture in a body of the engine; and an outlet valve for controlling exhaust of the working fluid from the cylinder, the outlet valve having an outlet valve stem passing through a second aperture in a body of the engine, wherein the first and second apertures form leakage points.

The enclosed space may be formed around both the first and second apertures.

The fluid engine may include a first valve stem sealing unit according to the first aspect arranged to seal the inlet valve stem; and a second valve stem sealing unit according to the first aspect arranged to seal the outlet valve stem.

The fluid engine may operate on a two stroke cycle.

The fluid engine may be a modified four stroke internal combustion engine.

The fluid engine may include a first cam for operating the inlet valve, wherein the first cam is constructed and arranged such that the inlet valve opens when the piston is at a first pre-determined position within the cylinder and closes when the piston is at a second pre-determined position within the cylinder.

The first predetermined position may be at or near top-dead centre, and wherein: for a first period, as the piston moves from top dead centre to bottom dead centre and the inlet valve is open, the down-stroke of the piston is driven by both ingress of the working fluid and expansion of the working fluid; and for a second period, as the piston moves from top dead centre to bottom dead centre and the inlet valve is closed, the down-stroke of the piston is driven by expansion of the working fluid only.

The first pre-determined positon and the second pre-determined position may be selected to ensure that substantially all of the working fluid is depressurised from an inlet pressure to an outlet pressure.

The working fluid at the inlet valve may be at a pressure greater than 5 bar.

According to a fourth aspect of the invention, there is provided a method of manufacturing a fluid engine, the method comprising: providing an engine unit comprising: an engine block; a crankcase having a crankshaft; a cylinder formed in the engine block, and a piston for driving the crankshaft working in the cylinder; a cylinder head closing the top of the cylinder; an inlet valve for controlling ingress of a working fluid into the cylinder, the inlet valve having an inlet valve stem passing through a first aperture in the cylinder head; and an outlet valve for controlling exhaust of the working fluid from the cylinder, the outlet valve having an outlet valve stem passing through a second aperture in the cylinder head; sealing the inlet valve stem with first sealing means according to the first aspect; and sealing the outlet valve stem with second sealing means according to the first aspect.

The method provides a simple and cost effective way of making a fluid engine that has a tight seal on the cylinders, so that the fluid engine may be used at high pressures.

The ability to use higher pressures, and the reduced leakage allows the use of working fluids that have lower vaporisation temperatures, such as refrigerants.

The engine unit may be an intermediate component of a four-stroke internal combustion engine.

The method may include encasing at least part of the engine in an enclosed space, and providing means for collecting working fluid that leaks into the enclosed space.

The method may include providing a first cam for operating the inlet valve and a second cam for operating the outlet valve, the first cam and second cam being constructed and arranged such that the piston is operated by a pressure change of the working fluid, without combustion of the working fluid.

The first cam may be constructed and arranged such that the inlet valve opens when the piston is at a first pre-determined position within the cylinder and closes when the piston is at a second pre-determined position within the cylinder.

The first pre-determined position may be at or near top dead centre, and wherein: for a first period, as the piston moves from top dead centre to bottom dead centre and the inlet valve is open, the down-stroke of the piston is driven by both ingress of the working fluid and expansion of the working fluid; and for a second period, as the piston moves from top dead centre to bottom dead centre and the inlet valve is closed, the down-stroke of the piston is driven by expansion of the working fluid only.

The first pre-determined position and the second pre-determined position may be selected to ensure that substantially all of the working fluid is depressurised from an inlet pressure to an outlet pressure.

The second pre-determined position may be selected in dependence on the working fluid.

The shape of the first cam may at least in part control the first pre-determined position and the second pre-determined position, and the method may further comprise:

selecting the shape of the first cam from a plurality of available cam shapes, each available cam shape associated with a different working fluid.

The working fluid may be a refrigerant.

The fluid engine and method of manufacturing a fluid engine will now be explained, by way of example only, with reference to the accompanying drawings, in which:

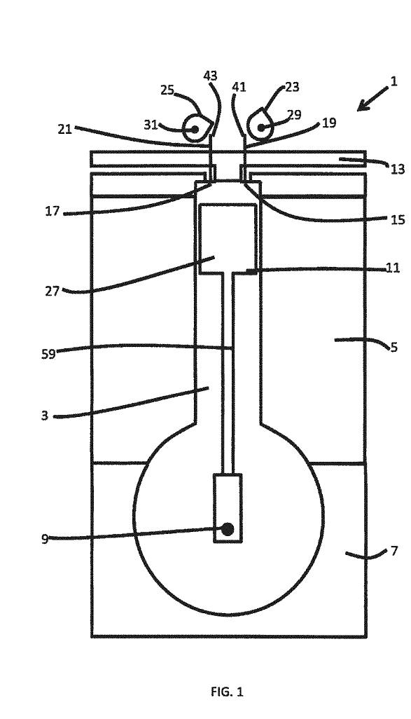

FIG. 1 illustrates a sectional schematic view of a cylinder of a fluid engine;

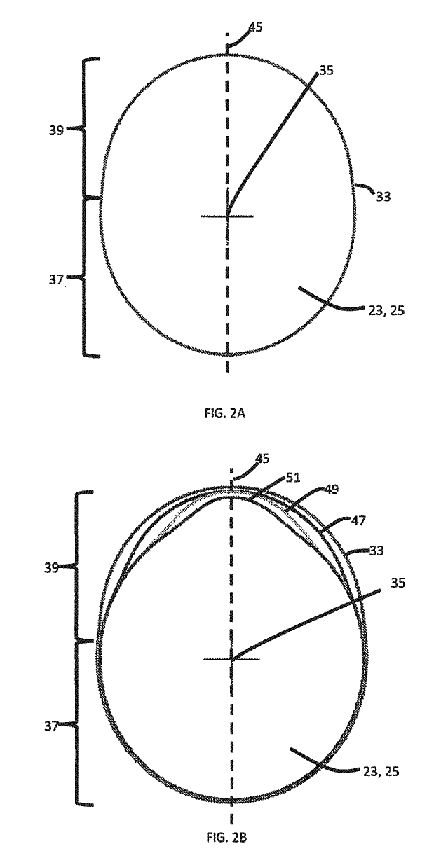

FIG. 2A shows an example profile of a cam for use in the engine of FIG. 1;

FIG. 2B shows a range of cam profiles, to hold valves open for different periods;

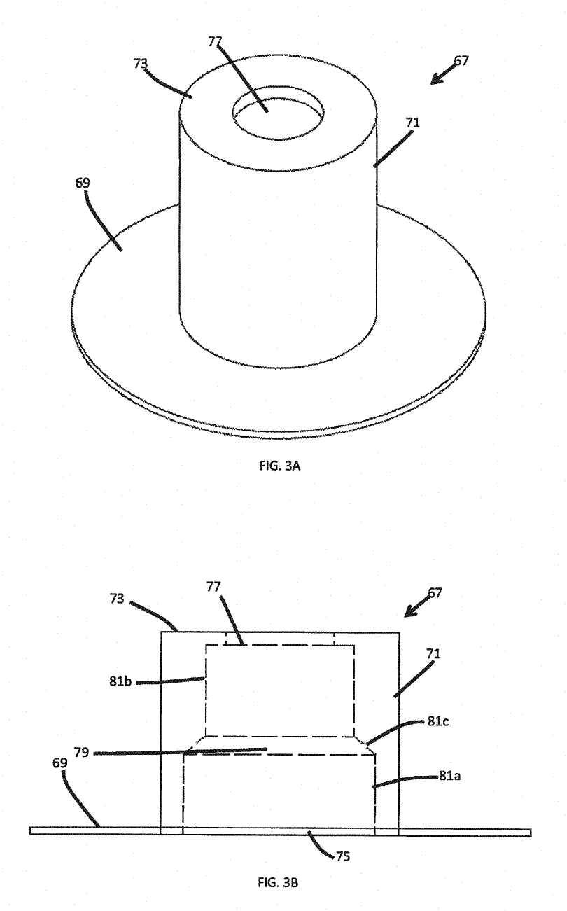

FIG. 3A shows a perspective view of a housing for a sealing unit used in the engine of FIG. 1;

FIG. 3B shows a cut-through sectional view of the housing in FIG. 3A;

FIG. 3C shows a cut-through section view of an assembled sealing unit;

FIG. 3D shows a cut-through section of an assembled unit arranged around a valve stem;

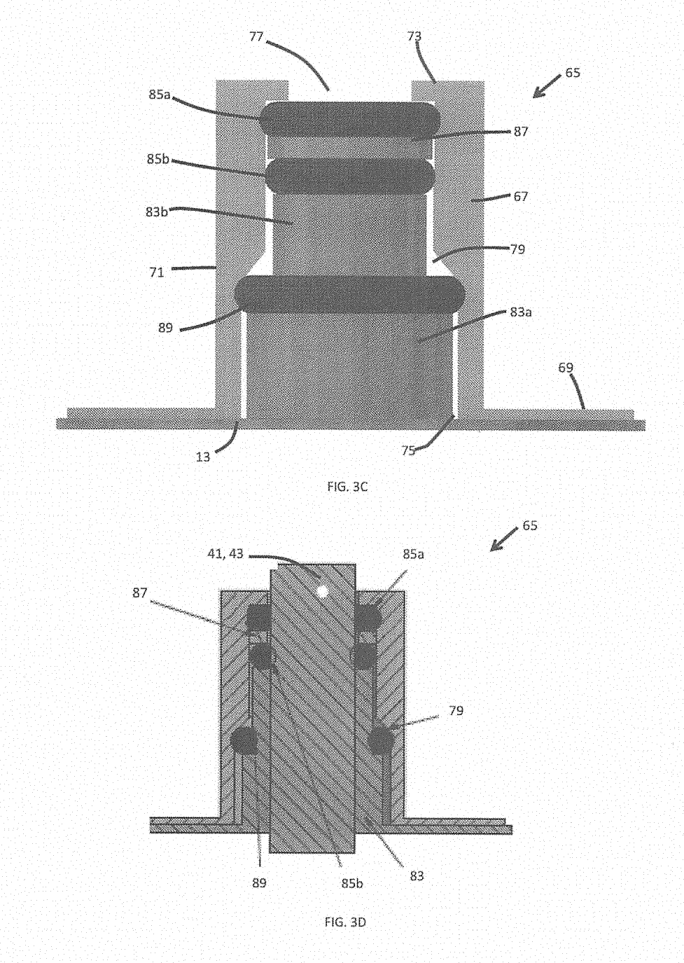

FIG. 4A illustrates a sectional schematic view of a cylinder incorporating a cover used in a working fluid collecting system;

FIG. 4B schematically shows a working fluid collecting system for collecting leaked working fluid;

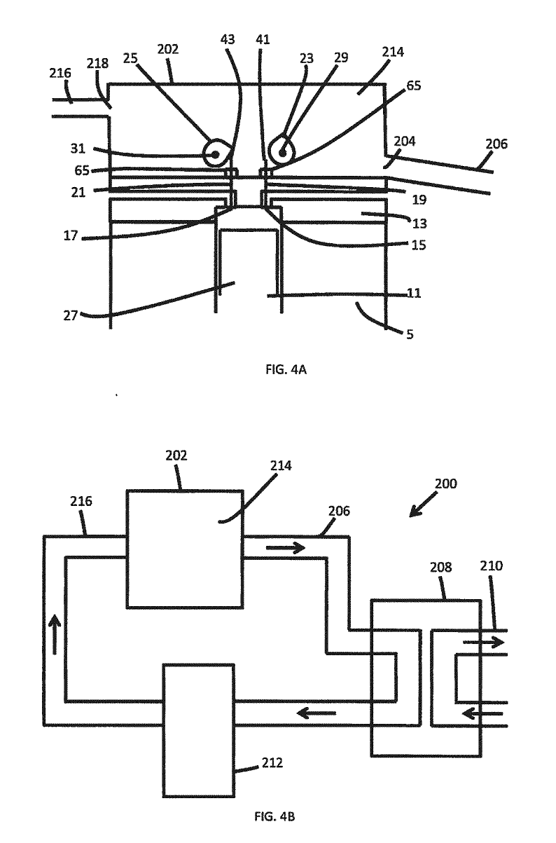

FIG. 5A shows a schematic plan view of a fluid engine incorporating four cylinders;

FIG. 5B shows a schematic side view of a fluid engine incorporating four cylinders;

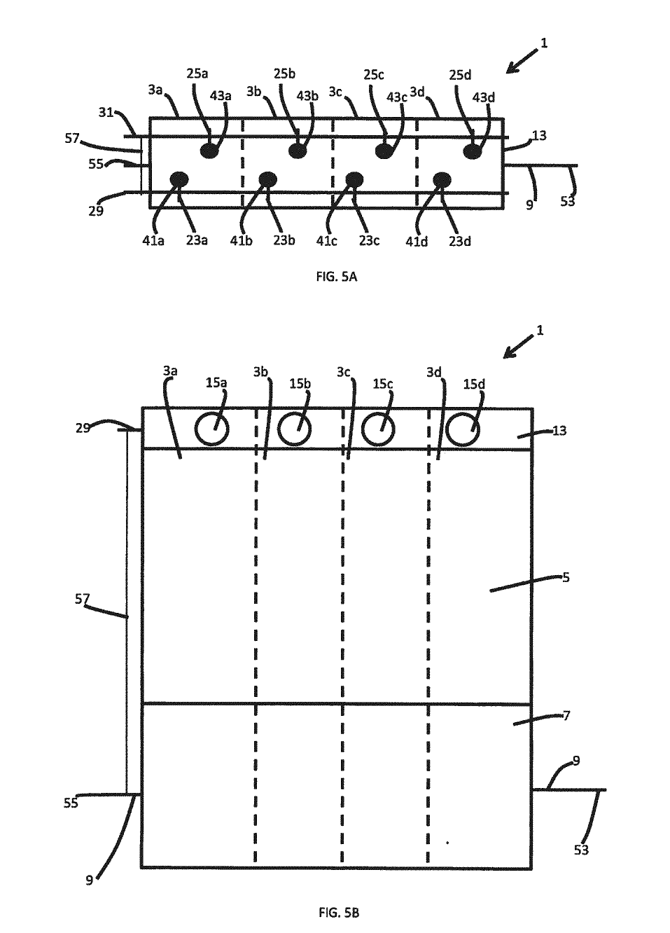

FIG. 6 shows a flow chart outlining the operation of the cylinder of FIG. 1;

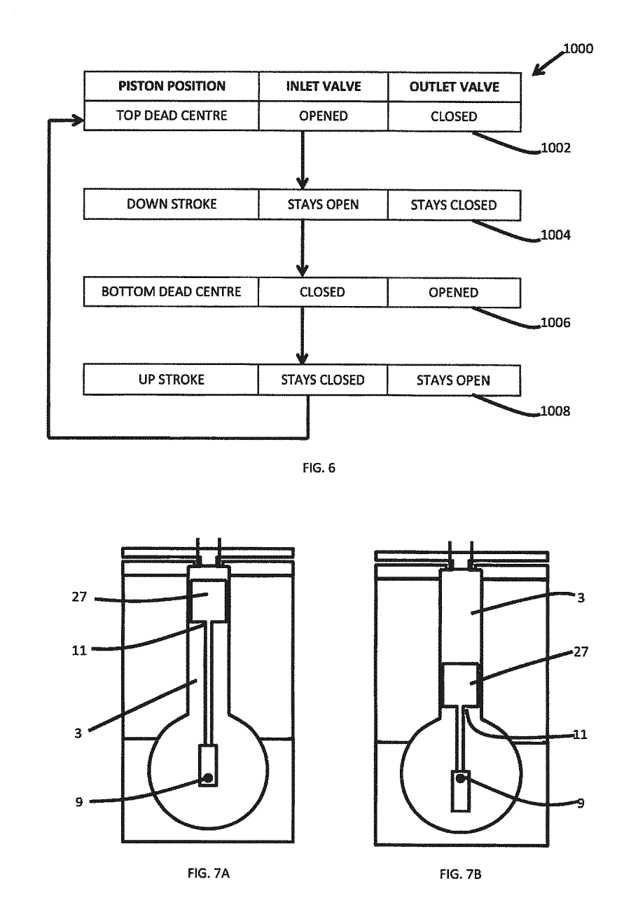

FIG. 7A shows the cylinder of FIG. 1 with the piston at top dead centre;

FIG. 7B shows the cylinder of FIG. 1 with the piston at bottom dead centre;

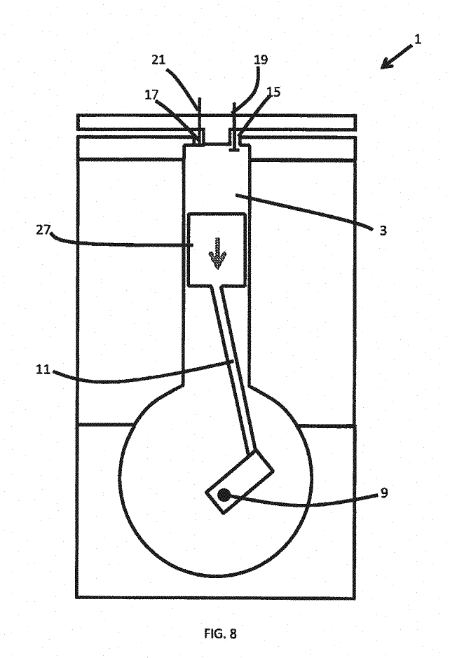

FIG. 8 shows the cylinder of FIG. 1 in a downward stroke of the piston;

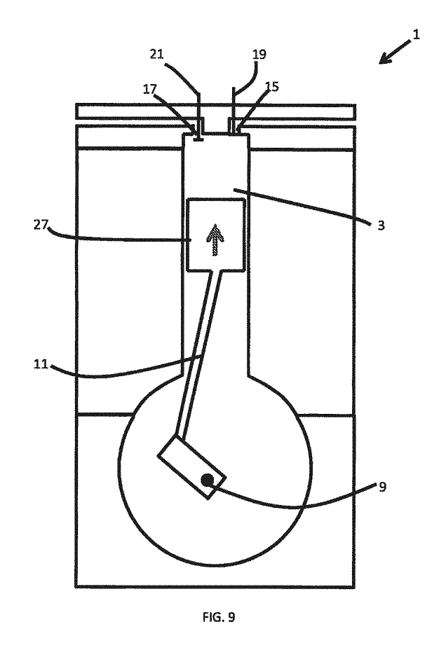

FIG. 9 shows the cylinder of FIG. 1 in an upward stroke of the piston;

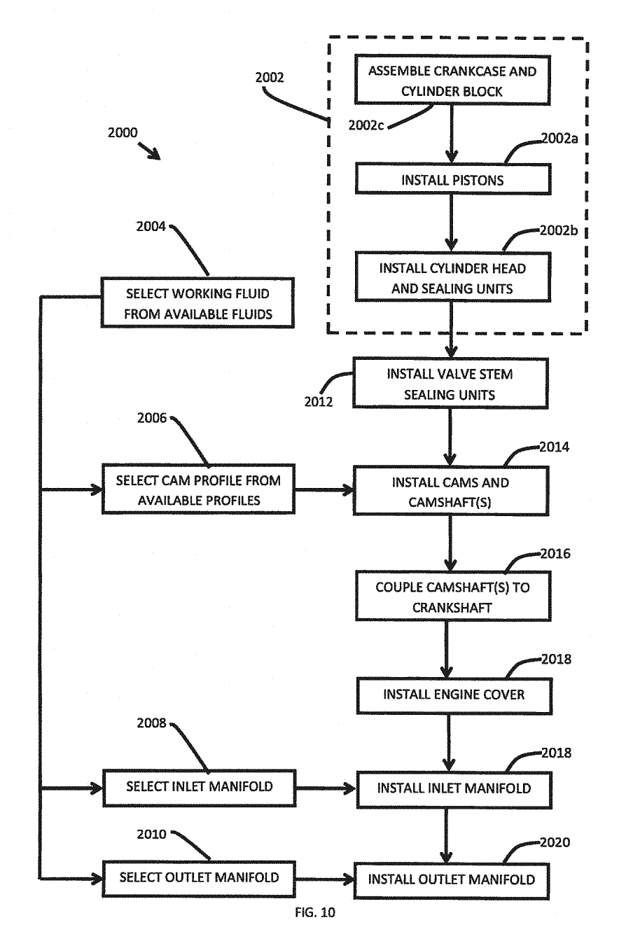

FIG. 10 shows a flow chart outlining a method of manufacturing a fluid engine;

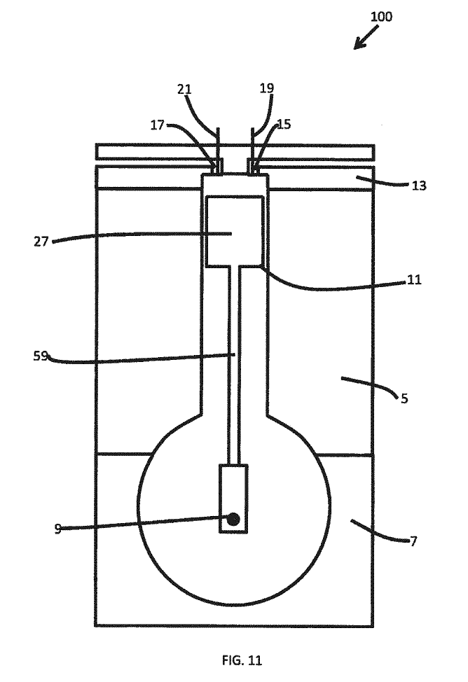

FIG. 11 shows a schematic view of a first embodiment of an engine unit for manufacturing a fluid engine;

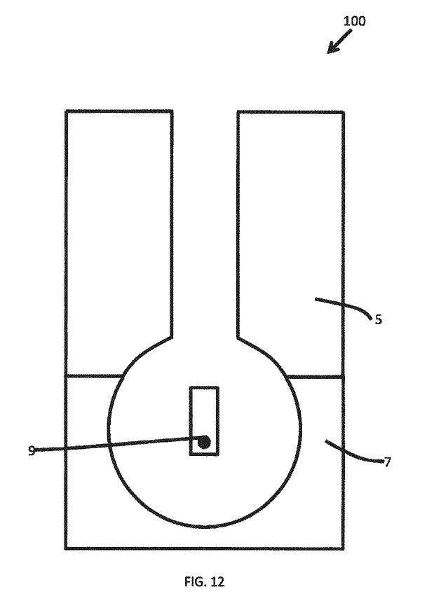

FIG. 12 shows a schematic view of a second embodiment of an engine unit for manufacturing a fluid engine; and

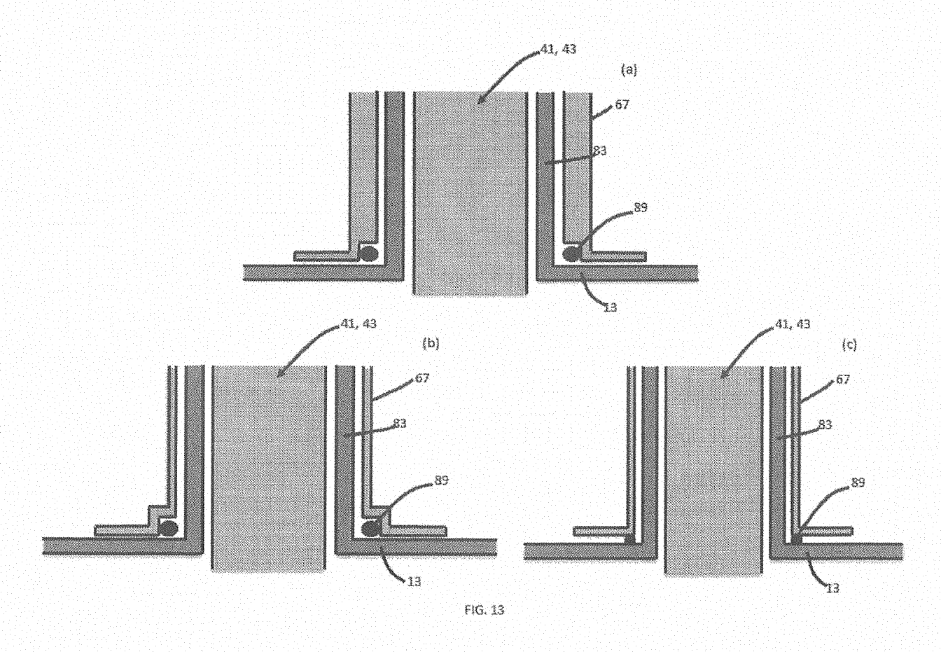

FIG. 13 shows three examples of a static seal of a sealing unit, with a straight valve guide.

FIG. 1 shows a schematic drawing of a cross section through a cylinder 3 of a fluid engine 1. The structure of the fluid engine 1 is similar to the structure of an internal combustion engine, such as a petrol or diesel engine for use in a car. The differences between the fluid engine 1 and an internal combustion engine will be discussed below.

The cylinder 3 is formed in a cylinder block 5 (also known as an engine block). At the base of the cylinder block 5, there is a crankcase 7, through which a crankshaft 9 runs. The cylinder block 5 and crankcase 7 may be formed separately and then joined together, or may be formed as a single unit.

The top of the cylinder 3 is closed by a cylinder head 13. The cylinder head 13 includes an inlet 15 into the cylinder 3 and an outlet 17 from the cylinder 3. The inlet 15 and outlet 17 are opened and closed by an inlet valve 19 and an outlet valve 21 respectively.

The valves 19, 21 are poppet valves, including a closing member for closing the inlet 15 or outlet 17, and a stem 41, 43 extending from the closing member. The valve stems 41, 43 pass through apertures in, and extend out of the cylinder head 3 or engine block 5.

The inlet valve 19 is operated by an inlet cam 23, and the outlet valve 21 is operated by an outlet cam 25. In the examples shown in the Figures, the cams 23, 25 are eccentric profiled discs. The inlet cam 23 is mounted on an inlet camshaft 29 and the outlet cam 25 is mounted on an outlet camshaft 31. The inlet camshaft 29 and the outlet camshaft 31 are coupled to the crankshaft 9 with a belt or chain (discussed in relation to FIGS. 4A and 4B), so that the camshafts 29, 31 rotate at the same speed as the crankshaft 9. Rotation of the camshafts 29, 31 in turn rotates the cams 23, 25.

The valves 19, 21 are biased to the closed position, in which the closing member closes the inlet 15 or outlet 17, by a spring (not shown). As the cams 19, 21 rotate, they engage respective valve stems 41, 43 and urge the valve open against the force of the spring, moving the closing member away from and opening the inlet 15 or outlet 17. Thus, the cams 23, 25 hold each valve 19, 21 open for a proportion of the rotation.

FIG. 2A shows an example of a cam 23, 25, showing the profile 33 (also referred to as the shape or circumference) of the cam 23, 25. The cross 35 illustrates the axis of the camshaft 23, 25. The cam 23, 25 has an eccentric axis 45 running vertically through it. The cam 23, 25 in FIG. 2A is formed of a part-circular section 37 and an extended section 39. The camshafts 29, 31 are mounted in proximity to the valve stems 41, 43, so that when the cam 23, 25 rotates with the camshaft 29, 31, the circular section 37 does not interact with the respective valve stem 41, 43. However, as the extended section 39 rotates past the respective valve stem 41, 43, it presses down on the valve stem 41, 43, holding the respective valve 19, 21 open.

In use, reciprocal motion of the piston 11 is driven by expansion of a working fluid inside the cylinder 3. In some examples, the pressure of the working fluid that is provided to the cylinder 3 is typically between 1 bar and 100 bar. The working fluid may be at a similar pressure after expansion. For example, the working fluid may be above 5 bar throughout the engine 1. This means the working fluid is often at higher pressure that the pressure typically experienced in an internal combustion engine (2 to 3 bar, or 4 bar in a turbo), and so working fluid may leak around the valve stems 41, 43 if standard seals from an internal combustion engine are used.

FIGS. 3A to 3D illustrate an example of a sealing unit (or sealing means) 65 used to seal a valve stem 41, 43 of a fluid engine 1. The sealing unit 65 is not shown in some of the Figures, for clarity.

The sealing unit 65 includes a valve stem housing 67. The housing 67 has an annular flange 69 at the base, and a cylindrical sidewall 71 extending from the internal edge of the annular flange 69. A top wall 73 is provided on top of the sidewall 71. As such, the housing can be seen to have a “top-hat” shape.

The top wall 74 also has a central aperture 77 (the top aperture), smaller than the flange aperture 75. Therefore, the housing 67 defines a through passage 79 between the flange aperture 75 and the top aperture 77. FIG. 3B shows a cut-through of the housing 67, showing the through passage 79 in more detail.

The through passage 79 includes a first cylindrical portion 81a of a first diameter, adjacent the flange aperture 75, and a second cylindrical portion 81b of a second diameter, smaller than the first diameter, adjacent the top aperture 77. A tapered portion 81c is provided between the cylindrical portions 81a, 81b, in which the diameter changes from the first diameter to the second diameter.

The first diameter is the same as the diameter of the flange aperture 75, and the second diameter is smaller than the first diameter, but larger than the diameter of the top aperture 77.

FIG. 3C shows a cut-through view of the partially assembled sealing unit 65, omitting the valve stem 41, 43 for clarity. The cylinder head 13 includes a valve guide 83a, b, c, projecting parallel to the valve stem 41, 43, for guiding the movement of the valve stem 41, 43. The housing 67 sits over the valve guide 83, with the valve guide 83 received in the through passage 79.

The valve guide 83 has a first cylindrical portion 83a, and a narrower second cylindrical portion 83b. The change between the portions 83a, 83b is a step change, forming a shoulder. In a normal combustion engine, this forms the seat for the valve stem seal. The location of the tapered portion 81c in the through passage 79 is arranged to coincide with step change (shoulder) in the valve guide 83, to form a seat to locate and compress a seal 89, as will be discussed below.

A first seal 85a and second seal 85b, separated by an annular washer 87 are provided in the space between the top of the valve guide 83 and the top wall 73 of the housing 67. The external diameter of the seals 85 and washer 87 is selected to form a seal with the walls of the through passage 79, in the second cylindrical portion 81b. The internal diameters of the seals 85 and washer 87 is selected to form a seal with a valve stem 41, 43 passing through the sealing unit 65, as shown in FIG. 3D. The seals 85 are rubber O-rings, and the washer 87 is a stainless steel or aluminium washer.

The first seal 85a rests against a seat formed by the change in diameter between the second diameter of the through passage 79, and the top wall 73 of the housing. The second seal 85b rests against a seat formed by the top of the valve guide 83. As such, the height of the second cylindrical section 81b is arranged to receive the seals 85 and washer 87, whilst allowing them to remain in contact.

A third seal 89 is provided in a seat formed between the step change in the valve guide 83, and the tapered portion of the housing 81c. The external diameter of the third seal 89 forms a seal with the through passage 79 in the first cylindrical portion 81a, at the join with the tapered portion 81c. The internal diameter of the third seal 89 is selected to form a seal with the second cylindrical portion 83b of the valve guide 83. The third seal is also a rubber O-ring.

The first and second seals 85 form a dynamic seal against the moving valve stem 41, 43. The second seal 85b acts to prevent egress from the gap formed between the valve stem 41, 43 and the valve guide 83. To achieve this, the second seal has an internal diameter that is narrower than the valve stem 41, 43, so that it is stretched and forms a tight seal. The first seal 85a has a larger diameter than the second seal 85b, and prevents egress of any working fluid that does escape past the second seal 85b from the top of the housing 67.

The third seal 89 forms a static seal between the valve guide 83 and the wall of the through passage 79, and prevents egress of any working fluid that does escape past the second seal 85b from the bottom of the housing 67.

As can be seen from FIG. 3D, the valve stem 41, 43 passes through the through passage 79, and out of the top of the housing 67.

In one example, the top wall 73 can form a base for receiving the spring for biasing the valve 19, 21 into the closed position. The valve stem 41, 43 includes a retainer (not shown) at its top. When the cam 23, 25 engages the valve stem 41,43, it pushes on the retainer, which pushes the spring and valve stem down.

In another example, the annular base 69 forms the base for the spring, and the spring is received around the housing 67. In this example, the spring may project above the top of the housing 67, in an expanded and compressed state. Alternatively, the retainer may be shaped to compress the spring below the top of the housing 67.

The spring acts on the sealing unit to compress the seals 85, 89 to ensure a tight seal is formed by the sealing unit 65. This is either by action on the top wall 73 or the annular flange 69. The first and second seals 85 are compressed by the top wall 73.

The third seal 89 is compressed by the tapered portion 81c. The height of the cylindrical portions 81 is tailored to ensure the correct compression is applied.

Due to the high pressures of the working fluid, the spring must be able to exert a greater force on the valves 19, 21 than in an internal combustion engine. Therefore, a stronger spring is required than in an internal combustion engine. In some examples, multiple nested springs may be provided. The action of the stronger spring also holds the housing 67 in place. The housing 67 is made of a soft metal, such as aluminium (Al) and the annular flange is between 0.5 and 3 mm in thickness. Therefore, the action of the spring causes deformation of the annular base 69 ensuring the housing sits properly in place.

Nitrogen gas is provided within the sealed spaces in the through passage 79, to provide an inert atmosphere, and prevent oxygen or nitrogen oxides entering the fluid engine 1.

A sealing unit 65, such as shown in FIGS. 3A to 3D, is provided on the inlet valve stem 41 and the outlet valve stem 43.

Although the sealing unit 65 provides a strong seal, minimising leakage from the valves 19, 21, there may still be some leakage of working fluid from the valves 19, 21. To address this, the engine may be provided with a working fluid collecting system 200, as shown in FIGS. 4A and 4B.

FIG. 4A shows the top section of a cylinder 3 of a fluid engine 1 incorporating the collecting system 200. A cover 202 is provided over the cylinder head 13. The cover 202 forms a seal with the top of the cylinder head 13, to create an enclosed sealed space 214 encasing the valve stems 41, 43, cams 23, 25 and camshafts 29, 31.

A drainage aperture 204 is formed in the cover 202, connected to a discharge pipe 206. As shown in FIG. 4B, the discharge pipe 206 is coupled to the hot side of a heat exchanger or condenser 208. The cold side of the heat exchanger or condenser 208 is coupled to a cold water system. Working fluid drains from the cover 202, though the aperture 206 to the heat exchanger 208, where heat is transferred from the working fluid, to the cold water, condensing the fluid. The condensed fluid is then passed to a reservoir 212.

Condensing of the fluid in the heat exchanger 208 creates a pressure differential within the collecting system 200. The higher pressure leaked working fluid is drawn into the discharge pipe by the pressure differential.

Nitrogen gas is provided within the space 214 defined by the cover 202. Therefore, a mixture of nitrogen and working fluid is collected in the reservoir 212. The reservoir 212 includes a separator that isolates and collects the working fluid. The nitrogen is fed back to the space 212 defined by the cover 202 through a nitrogen recycling pipe 216, and an inlet 218.

In one example, the reservoir 212 is emptied at regular intervals, allowing the working fluid to be returned to the fluid engine 1. In other examples, the reservoir may be monitored, and emptied as required. In yet further examples, the working fluid may automatically be recirculated back to the fluid engine 1, either on the inlet side 15 or the outlet side 17, or at any other suitable position in the working fluid system. This ensures that losses of working fluid are minimal.

Before the working fluid is returned to the fluid engine 1, it requires heating. Therefore, the reservoir may be provided with a heater, or other means for heating the working fluid (not shown).

The above describes a single cylinder of a fluid engine 1. However, it will be appreciated that as with any engine, the fluid engine 1 may have any number of cylinders 3. For example, the fluid engine may have a single cylinder, four cylinders, five cylinders, or more or fewer.

FIGS. 5A and 5B show a plan view and side view of a fluid engine 1 having four cylinders 3a-3d arranged along the crankshaft 9. The dashed dividing lines are for illustration only. The sealing units 65 and collecting system 200 are not shown, for clarity.

As can be seen from FIGS. 5A and 5B, the crankshaft 9 extends from both ends of the crankcase 7. This is the case for a fluid engine 1 with any number of cylinders 3. At one end 53 of the crankshaft 9, a load can be connected. At the other end 55, the crankshaft 9 is coupled to the camshafts 29, 31, which also project from the cylinder head 13. A chain 57 connects the camshafts 29, 31 to the crankshaft 9, so that rotation of the crankshaft 9 causes rotation of the camshafts 29, 31.

Any suitable belt 57 or chain can be used to couple the crankshaft 9 to the camshafts 29, 31 and the belt 57 or chain may couple directly to the shafts 9, 29, 31 or through toothed wheels (not shown) or other suitable means. The coupling may be via a single belt encompassing the crankshaft 9, and the camshafts 29, 31, or a first belt coupling the crankshaft 9 to the inlet camshaft 29 and a second belt coupling the crankshaft to the outlet camshaft 31. In another example, the crankshaft 9 may couple to the camshafts 29, 31 without use of a belt 57 or chain, via toothed wheels and the like. No gearing is required since the camshafts 29, 31 are required to rotate at the same speed as the crankshaft 9.

The working fluid is provided to the cylinder inlets 15, through an inlet manifold (not shown). The inlet valves 19 control when working fluid is provided into the cylinders 3. The inlet manifold, also known as an inlet conduit, starts as a single main supply. In an engine with a single cylinder 3, this is provided to the inlet 15. Otherwise, the inlet manifold divides to provide a supply of working fluid to each cylinder 3.

The inlet manifold can also be manipulated to provide volumetric control ensuring that the mass flow of the working fluid arriving in the cylinders is constant, no matter what the density, pressure and viscosity of the main supply.

The mass flow control can be achieved by a Venturi constriction or other suitable means. The mass flow controlling means can be provided in the main supply or in the separate cylinder supplies, where there are multiple cylinders 3. The mass flow controlling means may also be omitted altogether.

As discussed above, the working fluid that is provided to the cylinder 3 is typically between 1 bar and 100 bar. The inlet manifold should be constructed to withstand such pressures, and to provide equal pressure to each cylinder 3, where there is more than one cylinder 3. The inlet manifold should also be arranged to withstand the temperature of different working fluids.

Similarly, an outlet manifold or conduit (not shown) is connected to the cylinder outlets 17, to exhaust expanded working fluid from the cylinders 3. The outlet valves 21 control when each cylinder 3 is exhausted into the outlet manifold.

Within each cylinder 3, the pressure of the working fluid decreases from the starting pressure, and so the pressure of the working fluid in the outlet manifold will be lower than the pressure of the working fluid in the inlet manifold. However, in some circumstances both valves 19, 21 may be open at the same time. Accordingly, the working fluid may pass directly from the inlet manifold to the outlet manifold via the cylinder 3, without expansion and a subsequent reduction in pressure. To protect the outlet manifold should this occur, the outlet manifold needs to be constructed to withstand the same pressures and temperatures as the inlet manifold.

Any suitable working fluid can be used in the fluid engine 1. Some examples of working fluids that can be used include:
R245FA—a liquid refrigerant available from Honeywell;
R135—a liquid refrigerant available from Honeywell;
Other refrigerants;
Novec 7000—an engineering fluid available from 3M;
Compressed natural gas or compressed liquid gas—which can be transported at 3000 psi.

Some of the working fluids (for example refrigerants) can cause significant environmental damage if released into the open atmosphere. The use of the sealing units 65 and collecting system 200 can be particularly advantageous in these examples, to reduce the environmental impact of any leak.

The basic structure of the fluid engine 1 is the same regardless of the working fluid. However, the construction of the cams 29, 31, the construction of the inlet manifold (particularly any mass flow control element) and the construction of the outlet manifold is dependent on the characteristics of the working fluid, for example, the viscosity, density, temperature, highest pressure that can be achieved.

In the embodiments described above, the valves 19, 21 have been described as poppet valves biased to the closed position by a spring. However, it will be appreciated that in some embodiments, the valves may be desmodronic poppet valves that do not include a spring and are, instead, positively opened and closed. In the case of desmodronic valves, the inlet valve 19 is operated by a pair of inlet cams (one to open the valve and one to shut it) and the outlet 21 valve is operated by a pair of outlet cams (one to open the valve and one to shut it). Desmodronic valves will still make use of the sealing unit 200, to seal the valve stems 41, 43. Any other type of valve may also be used.

In some embodiments, only a single camshaft may be provided. In such embodiments, the inlet cam 23 and the outlet cam 25 will be mounted on the single camshaft. Similarly, the cams 23, 25 do not necessarily have to be formed of eccentric discs. Other types of cam are known and could be used.

In some embodiments of the fluid engine 1, the top surface of the piston head 27 may arranged so that the piston 27 does not impinge on the valves 19, 21. To achieve this, the piston head may have a concavity, a depression, an indentation or a recess (not shown). Alternatively, the piston head 27 may be sized such that means the piston 11 is separated from the valves 19, 21 even at top dead centre (see FIG. 7A). This arrangement increases the efficiency of the fluid engine 1 because the piston head 27 is prevented from impinging on the valves 19, 21.

It will be appreciated that construction of the sealing unit 65 described above is given by way of example only and any suitable construction may be used for the sealing unit 65. For example, any number of seals 85, 89 of any size may be formed and any number of O-rings may be used, to form the static seal prevent egress of working fluid from the bottom of the housing 67 and the dynamic seal preventing egress from the top. Also, any type of seal 85, 89 may be used instead of rubber O-rings.

Furthermore, the through passage 79 may include a step change (shoulder) between the first and second diameters, instead of the tapered portion 81c, and any step change, ledge or projection may be used to compress the seals 85, 89.

In addition, any suitable shape and construction of valve guide 83 may be used. In some examples, the valve guide 83 is straight, with constant diameter and without a shoulder. FIG. 13 shows three examples of how the static seal used to prevent egress of working fluid from the bottom of the housing 67 is formed with a straight valve guide 83. FIG. 13 only shows the static seal in detail. The dynamic seal is as described above.

In the examples shown in FIG. 13, the third seal 89 rests on the cylinder head 13 of the engine 1. In the example shown in FIG. 13(a), the third seal 89 rests between the cylinder head 13, and a shoulder in the inner diameter of the through-passage 79. The sidewall 71 of the housing 67 is of constant diameter. In the example shown in FIG. 13(b), the third seal 89 again rests between the cylinder head 13, and a shoulder in the inner diameter of the through-passage 79, however the sidewall 71 also includes a shoulder. In the example shown in FIG. 13(c), the third seal 89 rests between the cylinder head 13 and the underside of the flange 69 of the housing 67. These arrangements are given by way of example only, and the third seal 89 could be provided in any suitable location.

The housing 67 may be made of any suitable material, for example, metal or plastics, and can be fixed in places. In some cases, where a soft material is not used, a washer or gasket may be provided between the housing 67 and the cylinder head 13.

In the examples shown above, the annular flange 69 forms a flat base. However, it will be appreciated that the flange may be shaped to match the cylinder head, and/or may be shaped to curve upwardly at the edges to focus the force of the spring.

In some examples, the sealing unit 65 may be omitted altogether, and just the collecting system 200 may be relied on to prevent working fluid escaping into the environment. This may be the case in some smaller engines, which do not have room to accommodate the housing 67.

The cover 202 in the working fluid collecting system may encase the whole of the cylinder head 13, or separate covers may be provided for different parts of the engine 1. Furthermore, other parts of the engine 1, such as where the inlet manifold and outlet manifold connect to the inlet and outlets may be enclosed in separate spaces provided within a working fluid collecting system.

It will also be appreciated that any heat exchange fluid can be used in place of cold water.

In some examples, the collecting system 200 may include a pump, fan or some other circulating means to help drive the nitrogen and nitrogen/working fluid mixture around the collecting system, although this is not essential.

It will also be appreciated that the collecting system 200 described above is by way of example only, and any suitable system for collecting leaked working fluid may be used.

Another example of a working fluid collecting system 200 omits the condenser 208, and instead provides a cooled jacket around the cover 202. This may be cooled by the same heat exchange fluid used in the heat exchanger 208. In this example, the working fluid condenses in the cover 202, and is drawn into the reservoir 212 as discussed above.

In some examples, the collecting system 200 may be omitted altogether.

In the above description, the use of nitrogen in the sealing unit 65 and collecting system 200 has been described. This ensures no oxygen, nitrogen oxides, or other contaminants enter the fluid engine 1. In some examples, the nitrogen may not be used, and the collecting system 200 may include pure working fluid (meaning that a separator is not necessary). In other examples, any suitable inert gas may be used.

The operation of the fluid engine 1 will now be described with reference to FIGS. 6 to 9.

FIG. 6 shows the method 1000 by which a cylinder 3 of a fluid engine 1 operates. The piston 11 may be in any position in the cylinder 3 at the start of the operation, but for convenience, it will be considered that the piston 11 starts at top dead centre.

FIG. 7A illustrates a piston 11 at top dead centre. In this position, the piston head 27 is at its maximum vertical spacing from the crankshaft 9.

At a first step 1002, the inlet valve 19 is opened. The outlet valve 21 is closed. This causes working fluid to enter the cylinder 3, from the supply system.

In a second step 1004, the piston 11 goes through a downward stroke, as shown in FIG. 8. In the downward stroke, there are two separate factors driving the piston 11 down. The first factor is the ingress of the working fluid acting on the piston 11. The second is the expansion of the working fluid acting on the piston 11. Initially, as the inlet valve 19 is opened, it is the ingress of the working fluid that drives the piston 11. However, almost immediately, the fluid will start to expand and this will also drive the piston 11.

The downward stroke causes 180 degrees of rotation of the crankshaft 9, such that at the end of the stroke, the piston 11 is at bottom dead centre.

FIG. 7B illustrates a piston 11 at bottom dead centre. In this position, the piston head 27 is at its minimum vertical spacing from the crankshaft 9.

At a third step 1006, when the downward stroke has ended (piston at bottom dead centre), the inlet valve 19 is closed and the outlet valve 21 is opened. The expanded working fluid begins to be drawn through the outlet valve 21. In a final step 1008, the piston 11 goes through an upward stroke, as shown in FIG. 9. In the upward stroke, the expanded working fluid is drawn through the outlet 17. The upward stroke ends when the piston 11 reaches top dead centre. The operation then returns to the first step 1002, where the outlet valve 21 is closed and the inlet valve 19 opened.

By this method of operation, the expansion of the working fluid is able to drive reciprocal motion of the piston 11 and hence drive the crankshaft 9. There is no combustion of the working fluid and the working fluid is chemically unchanged by the process. Therefore, substantially all of the working fluid provided into the cylinder is recovered in the exhaust system. Unlike convention internal combustion engines, the energy for driving the piston 11 is derived externally of the cylinder 3.

The fluid engine 1 is a two-stroke engine, because the engine 1 completes a full crankshaft 9 rotation within two strokes of the piston 11 (the upward stroke and the downward stroke).

The piston 11 may be driven by any suitable pressure change in the working fluid. The pressure change may be accompanied by a state change (e.g. from gas to liquid) or may not. The working fluid provided through the inlet may be a liquid, gas or mixture of the two.

In the example discussed above, the inlet valve 19 is open for the full downward stroke of the piston 11 (180 degrees of crankshaft rotation) and the outlet valve 21 is open for the full upward stroke of the piston 11 (180 degrees of crankshaft rotation). However, this is only one example of the timings that may be used. The choice of inlet valve opening period is dependent on the working fluid and a number of other factors including design choice and efficiency—the most efficient opening period does not need to be 180 degrees.

FIG. 2B shows a number of cam profiles 33, 47, 49, 51 that may be used. As can be seen, the circular section 37 of the four profiles are identical. However, the extended section 39 varies to vary the period for which the associated valve 19, 21 is held open.

The outermost profile 33 is the same as that shown in FIG. 2A and is included for comparison. The next profile 47 corresponds to 135 degree valve opening, the third profile 49 corresponds to ninety degree valve opening and the innermost profile 51 corresponds to 70 degree valve opening.

As can be seen, as the period a valve 19, 21 is held open for decreases, the extended section 39 of the cam 23, 25 becomes sharper. These profiles are exemplary only, and it will be appreciated that the cam profile can be varied to achieve anywhere between 0 degree and 180 degree opening.

In the examples discussed above, the cams 23, 25 are constructed so that the inlet valve 19 and outlet valve 21 are each opened once per rotation of the cams 23, 25. The cams 23, 25 are rotated by rotation of the camshafts 29, 31, and the camshafts 29, 31 are driven at the same speed as the crankshaft 9, so the valves 19, 21 are also opened once for each rotation of the camshafts 29, 31 and the crankshaft 9.

In other examples, the cams 23, 25 may be arranged so that the valves 19, 21 open twice for each full rotation of the cams 23, 25. In such examples, each cam 23, 25, is made of two extended sections 39, directly opposite one another around the cam 23, 25. Accordingly, the eccentric axis 45 will run through the centre of both extended sections 39. To maintain the correct two-stroke operation of the fluid engine 1, such a cam 23, 25 will need to rotate at half of the speed of the crankshaft 9, so that the crankshaft 9 rotates twice for each cam 23, 25 rotation. This can be achieved by proper gearing of the camshafts 29, 31 and the crankshaft 9.

Typically, the inlet valve 19 will open at top dead centre, or within 25 degrees of crankshaft 9 rotation before or after top dead centre. Similarly the outlet valve 21 will typically open at bottom dead centre, or within 25 degrees of crankshaft 9 rotation before or after bottom dead centre. However, the inlet valve 19 may also open at any suitable point after top dead centre, and the outlet valve 21 may also open at any suitable point after bottom dead centre. In some examples, the inlet valve 19 and outlet valve 21 may be open at the same time.

The cams 29, 31 should be installed so that the eccentric axis 45 of both cams 23, 25 aligns properly with the piston 11, such that the valves 19, 21 are opened at the correct times.

In most examples, the outlet valve 21 will be opened for 180 degrees, although a shorter or longer period is possible. The inlet valve 19 opening period is more variable and can be chosen depending on the desired application, environment, working fluid and other parameters.

As discussed above, the downward stroke is driven by two different factors: the ingress of working fluid and the expansion of working fluid. If the inlet valve 19 is open for the whole duration of the stroke between top dead centre and bottom dead centre, the piston 11 is driven by both factors over the stroke, once expansion has started. However, if the inlet valve 19 is not open for the full duration of the downward stroke, the piston 11 is driven by expansion only, once the inlet valve 19 is closed.

Depending on the working fluid and the pressure of the working fluid at the inlet 15, closing the inlet valve 19 at bottom dead centre can mean that not all of the working fluid properly expands. For example, if the inlet valve 19 is open for 180 degrees, it is likely that the working fluid will not expand efficiently.

Conversely, closing the inlet valve 19 too early can mean that the working fluid has fully expanded before the piston 11 reaches bottom dead centre, and the piston is not driven for the full downward stroke of the engine. This can lead to uneven driving of the engine 1 over the rotation of the crankshaft 9. Therefore, correct choice of the period the inlet valve 19 is open for can increase the efficiency of the engine. Generally, the inlet valve opening period will be between 35 degrees and 135 degrees.

The above description focuses on the operation of a single cylinder 3, in order to demonstrate how the fluid engine 1 works in principle. However, as discussed above, the fluid engine 1 may have any number of cylinders 3. FIGS. 5A and 5B show, for example, a fluid engine 1 having four cylinders 3.

In one example of the operation of a fluid engine 1 having four cylinders, the cylinders 3 are grouped so that the first and fourth cylinders 3a, 3d operate in parallel and the second and third cylinders 3b, 3c operate in parallel, shifted by 180 degrees from the first and fourth cylinders 3a, 3d. In other words, whilst the first and fourth cylinders 3a, 3d are on downward strokes, the second and third cylinders 3b, 3c are on upward strokes and vice versa. The period that the inlet valve 17 is open for can be controlled, by selection of the cam profile, so that the down stroke is always driven by at least expansion of the working fluid. In this case, the most efficient engine 1 is achieved by ensuring the expansion drives the piston 11 to bottom dead centre, although this is not essential.

This timing ensures relatively even distribution of power throughout the rotation of the crankshaft 9. In some examples, the downward stroke of the first group of cylinders 3a, 3d helps to drive the upward stroke of the other cylinders 3b, 3c (and vice versa).

In another example, the cylinders 3 may be arranged so that no piston 11 is driven by expansion to bottom dead centre, but the pistons 11 are phased so that the crankshaft 9 is always driven by one or more pistons 11 that are driven by expansion.

These groupings are by way of example only. In a fluid engine 1, the cylinders may be grouped into two groups operating at 180 degree difference, or the cylinders 3 may all operate in parallel, or the cylinders 3 may all operate spaced from one another or in any number of groups, spaced by different amounts. The cylinders 3 may be grouped so that the crankshaft 9 is driven by a downward stoke of one or more pistons 11 throughout its rotation.

Alternatively, the cylinders 3 may be grouped so that the crankshaft 9 is driven in a phased manner.

A method of manufacturing a fluid engine 1 will now be described with reference to FIGS. 10 to 12. FIG. 10 shows a flow chart of the method 2000.

At a first step 2002, an engine unit 100 is provided. An engine unit 100 is the basis used for forming the fluid engine 1. Before the subsequent steps of the current method 2000 are performed, the engine unit 100 can also be suitable for forming the basis of a four-stroke internal combustion engine, and indeed may be intended for this purpose. The engine unit 100 may be formed of any suitable material including metal and plastics.

FIG. 11 shows one example of an engine unit 100. The engine unit comprises the crankcase 7, crankshaft 9, cylinder block 5, piston 11, cylinder 13 and the inlet 15, outlet 17 and associated valves 19, 21.

In a further initiating step 2004, the working fluid is selected or determined. The working fluid may be dictated by external circumstances (for example a fluid used in a pre-existing system) or may be selected to best match the requirements of the current application.

In a further step 2006, the desired cam profiles are selected and the structures of the inlet and outlet manifolds are selected 2008, 2010.

The shapes of the cams 23, 25 (and hence the period for which the inlet 15 and outlet 17 are open) are selected based on the desired operation of the fluid engine 1 (for example, what proportion of the down-stroke of the piston should be driven by expansion alone, the desired output pressure), which in turn may vary for different working fluids.

Similarly, different working fluids may require different inlet and outlet manifolds. For example, the temperature and pressure tolerances of the manifolds may vary for different working fluids. The manifolds may also vary depending on the desired flow characteristics.

In a first assembly step 2012, the valve sealing units 65 are installed. This may involve removing the valves 19, 21, and valve springs, and then installing new valve springs once the sealing units 65 are installed. In a second assembly step 2014, the cams 23, 25 are mounted on the camshafts 29, 31 and the camshafts 29, 31 are installed onto the cylinder head 13. Then, at the next step 2016, the crankshaft 9 is coupled to the camshafts 29, 31. Then, the engine cover 202 is installed at step 2018.

The cover 202 is fitted in the location of the original cover of the internal combustion engine, using the same seal. The cover 202 may be purpose built, or made by modification of the original engine cover. This modification may include providing the discharge aperture and nitrogen aperture, and sealing any existing apertures.

The selected inlet manifold is installed at step 2020 and at a final step 2022, the outlet manifold is installed.

The fluid engine 1 is then completed as shown in FIG. 1, and ready for installation into a larger system including a working fluid supply for providing working fluid to the inlet manifold, exhaust system for carrying away working fluid, and a load on the crankshaft 9.

It will be appreciated that steps 2002 and 2004 must precede the other steps. Also step 2006 must precede step 2014, step 2014 must precede step 2016, and step 2016 must precede step 2018. Similarly, step 2008 must precede step 2020 and step 2010 must precede step 2022. Otherwise, the method 2000 can be completed in any order. Where one step must precede another, there may be unrelated intermediate steps between them.

The engine unit 100 is an intermediary product for making a standard four-stroke engine. However, the engine 1 is no longer suitable for that use, once it has been through the manufacturing method 2000. Instead, the engine 1 is a two-stroke engine that uses an external source for power.

In particular, the fluid engine 1 does not include any means to combust a fuel within the cylinder(s) 3. This is different to an internal combustion engine, where at least some of the fuel is combusted (either with or without ignition of the fuel).

In addition, in the fluid engine 1 having cams 23, 25 that open the valves 19, 21 once per rotation, the camshafts 29, 31, and therefore the cams 29, 31, are arranged to rotate at the same speed as the crankshaft 9. This is different to a four-stroke engine, where the crankshaft 9 rotates twice for each rotation of the. camshafts 29, 31. In a fluid engine 1 having cams 23,25 that open the valves 19, 21 twice per rotation, the crankshaft 9 and camshaft 29, 31 rotation will be the same as for a four-stroke engine.

The inlet manifold and outlet manifold are also different in the fluid engine 1. Firstly, the manifolds in the fluid engine 1 are required to withstand much higher pressures than in an internal combustion engine. Secondly, in an internal combustion engine, a mixture of fuel and air is provided into the cylinder(s) 3. However, in the fluid engine 1, only the working fluid is provided.

The engine unit 100 may be an intermediary for making an internal combustion engine suitable for use in a car (and may be diesel or petrol). Alternatively, the engine unit may be for making smaller engines (for example a lawn mower) or larger engines (for example for ships).

Within the cylinder block 5 or cylinder head 13 of the engine unit 100, apertures may be provided associated with the function as a four-stroke internal combustion engine. These may be for, for example, spark plugs, fuel injection systems, cooling systems etc. . . . .

These apertures are not required for operation as fluid engine 1. The method 2000 may, therefore include a further step of blocking any unwanted holes. When the holes are blocked, a seal is formed so that none of the working fluid escapes the cylinder, in use.

In some examples of engine units 100, each cylinder 3 may have multiple inlets 15. The fluid engine 1 may only use one inlet 15 per cylinder 3, with the remaining inlets 15 sealed. Alternatively the inlet manifold may be arranged to supply fluid to some or all of the inlets 15. Similarly, if a cylinder has multiple outlets 17, only one may be used, or some or all may be used, with the unused outlets blocked.

The engine unit 100 may be taken at any point of the manufacturing process of a four-stroke internal combustion engine. In the example described with reference to FIG. 11, the engine unit 100 is taken at the point at which the valves 19, 21 need to be removed to facilitate installation of the sealing units 65, but there is no other removal of components required to form the fluid engine 1.

The engine unit 100 may be taken at a point where there are no further common manufacturing steps and/or components between the internal combustion engine and the fluid engine 1.

In other examples, the engine unit 100 may be taken earlier in the process of manufacturing an internal combustion engine. FIG. 12 shows an example of one such engine unit 100. In this case, the engine unit 100 includes the crankcase 7, crankshaft 9 and the cylinder block 5. In this example, the step 2002 of providing the engine unit may comprise a first sub step 2002a of installing the pistons 11 and a second sub step 2002b of installing the cylinder head 13 and sealing units 65.

In alternative examples the engine unit may include the pistons 11 (either the piston rod only or the piston rod and head) and the method may include installing the piston head 27, if necessary, and then installing the cylinder head 13.

In other examples, the engine unit 100 may be taken from earlier in the manufacturing process, and the method 2000 may include the additional step 2000c of assembling the crankcase 7 and/or the crankshaft 9 and/or the cylinder block 5.

In yet further examples, the engine unit 100 may be taken from further along the four-stroke internal combustion engine manufacturing process (even up to a completed engine). In such examples, the method may include the step of partially disassembling the engine unit. The partial disassembly may include removal of, for example, cams 23, 25, inlet manifolds, outlet manifolds and decoupling the camshafts 29, 31 from the crankshaft 9.

In some examples, the engine unit 100 may not be an engine unit 100 from a four-stroke internal combustion engine. In some examples, the engine unit may be purpose made for a fluid engine 1. For example, the engine unit 100 may be made of plastics, and made by 3D printing or injection moulding.

It is relatively straightforward to make fluid engines 1 for different uses using the above method 2000, since there are many common parts regardless of the working fluid. For examples, a number of different cam profiles, inlet manifolds and outlet manifolds may be provided. The method 2000 can be adjusted by simply selecting different one of the cam profiles and manifolds. The installation of the cams and manifolds is unchanged.

As discussed above, in some embodiments, the piston head 27 may be modified to prevent the piston 11 impinging on the valves 19, 21. This may be a further difference between the fluid engine 1 and a four-stroke internal combustion engine. The method 2000 for manufacturing the fluid engine 1 may be adapted in a number of different ways to incorporate this.

In one example, the engine unit 100 used at the start of the method may be as shown in FIG. 12, and not include pistons 11. In such an example, the pistons 11 can be formed at the correct size, or with the concavity, depression, indentation or recess in the piston head 27, or the pistons can be altered to reduce the size of the piston head 27, or to include the concavity, depression, indentation or recess, before they are installed.

In other examples, where the engine unit 100 already includes pistons 11, the method 2000 may include the step of removing the pistons 11. The removed pistons 11 may then be altered and reinstalled or new pistons 11 may be formed and installed. In other examples, the pistons 11 may be altered in situ. Depending on the structure of the engine unit 100, accessing the pistons in this way may include the step of removing the cylinder head 13 and then replacing it once the pistons 11 have been changed or altered.

1-15. (canceled)

15. A fluid engine arranged to be driven by a change in pressure of a working fluid, the fluid engine having one or more possible leakage points, and including a working fluid collecting system, to collect any working fluid that leaks from the leakage points, the working fluid collecting system including:
a cover constructed and arranged to form a sealed space around at least one of the leakage points;
means for condensing working fluid leaking into the cover; and
means for collecting the condensed working fluid.

16. The fluid engine of claim 15, wherein the means for condensing the working fluid includes a heat exchange fluid at lower temperature than the working fluid, such that heat exchange between the working fluid and heat exchange fluid cools the working fluid.

17. The fluid engine of claim 16, wherein the means for condensing the working fluid includes a heat exchanger for exchanging heat between the working fluid and the heat exchange fluid.

18. (canceled)

19. The fluid engine of claim 16, wherein the means for condensing the working fluid includes a cooling jacket arranged around the cover, such that the working fluid condenses in the space formed by the cover.

20. (canceled)

21. The fluid engine of claim 20, wherein the space formed by the cover is held in an inert nitrogen environment.

22. The fluid engine of claim 21, wherein the means for collecting the condensed working fluid includes a separator for separating the working fluid from the nitrogen.

23. (canceled)

24. The fluid engine of claim 15, wherein the working fluid collecting system includes means for recycling collected working fluid to the input or output of the fluid engine.

25. The fluid engine of 15, wherein the working fluid collecting system includes means for drawing working fluid through the working fluid collecting system.

26. The fluid engine of claim 15 including:
a piston, received in a cylinder, the piston being driven, in use, by the pressure change in the working fluid.

27. (canceled)

28. The fluid engine of claim 26, including:
an inlet valve for controlling ingress of the working fluid into the cylinder, the inlet valve having an inlet valve stem passing through a first aperture in a body of the engine; and
an outlet valve for controlling exhaust of the working fluid from the cylinder, the outlet valve having an outlet valve stem passing through a second aperture in a body of the engine,
a first valve stem sealing unit arranged to seal the inlet valve stem; and
a second valve stem sealing unit arranged to seal the outlet valve stem,
wherein the inlet valve and outlet valve are poppet valves and the first and second valve stem sealing units include:
a housing defining a through passage running from a first end to a second end, the through passage being arranged to receive a portion of the valve stem;
a first seal arranged to form a seal between the valve stem and the housing to prevent egress of the working fluid from the first end of the housing; and
a second seal arranged to form a seal between the housing and a body of the engine to prevent egress of the working fluid from the second end of the housing
wherein the first and second apertures form leakage points, and
wherein the enclosed space is formed around both the first and second apertures.

29. (canceled)

30. (canceled)

31. The fluid engine of claim 15, wherein the fluid engine operates on a two stroke cycle.

32. The fluid engine of claim 15, wherein the fluid engine is a modified four stroke internal combustion engine.

33. The fluid engine of claim 15, including a first cam for operating the inlet valve, wherein the first cam is constructed and arranged such that the inlet valve opens when the piston is at a first pre-determined position within the cylinder and closes when the piston is at a second pre-determined position within the cylinder.

34. The fluid engine of claim 33, wherein the first predetermined position is at or near top-dead centre, and wherein:
for a first period, as the piston moves from top dead centre to bottom dead centre and the inlet valve is open, the down-stroke of the piston is driven by both ingress of the working fluid and expansion of the working fluid; and
for a second period, as the piston moves from top dead centre to bottom dead centre and the inlet valve is closed, the down-stroke of the piston is driven by expansion of the working fluid only.

35. (canceled)

36. (canceled)

37. A method of manufacturing a fluid engine, the method comprising:
providing an engine unit comprising:
an engine block;
a crankcase having a crankshaft;
a cylinder formed in the engine block, and a piston for driving the crankshaft working in the cylinder;
a cylinder head closing the tops of the cylinder;
an inlet valve for controlling ingress of a working fluid into the cylinder, the inlet valve having an inlet valve stem passing through a first aperture in the cylinder head; and
an outlet valve for controlling exhaust of the working fluid from the cylinder, the outlet valve having an outlet valve stem passing through a second aperture in the cylinder head;
encasing at least part of the engine in a sealed space around at least one leakage point in the engine; and
providing means for condensing working fluid that leaks into the sealed space and means for collecting the condensed working fluid.

38. The method of claim 37, wherein the engine unit is an intermediate component of a four-stroke internal combustion engine.

39. (canceled)

40. The method of claim 37, including:
providing a first cam for operating the inlet valve and a second cam for operating the outlet valve, the first cam and second cam being constructed and arranged such that the piston is operated by a pressure change of the working fluid, without combustion of the working fluid
wherein the first cam is constructed and arranged such that the inlet valve opens when the piston is at a first pre-determined position within the cylinder and closes when the piston is at a second pre-determined position within the cylinder; and
wherein the shape of the first cam at least in part control the first pre-determined position and the second pre-determined position, the method further comprising:
selecting the shape of the first cam from a plurality of available cam shapes, each available cam shape associated with a different working fluid.

41-46. (canceled)

47. The method of claim 37, wherein the means for condensing the working fluid includes a heat exchange fluid at lower temperature than the working fluid, such that heat exchange between the working fluid and heat exchange fluid cools the working fluid.

48. The method of claim 47, wherein the means for condensing the working fluid includes a heat exchanger for exchanging heat between the working fluid and the heat exchange fluid.

49. The method of claim 47, wherein the means for condensing the working fluid includes a cooling jacket arranged around the cover, such that the working fluid condenses in the space formed by the cover
